(19) United States
(12) Patent Application Publication
(10) Pub. No.: US 2016/0206943 A1
(43) Pub. Date: Jul. 21, 2016

(54) MARTIAL ARTS TRAINING SYSTEM AND APPARATUS

(71) Applicants: George Campbell, Hot Springs, AR (US); Garron Campbell, Hot Springs, AR (US)

(72) Inventors: George Campbell, Hot Springs, AR (US); Garron Campbell, Hot Springs, AR (US)

(21) Appl. No.: 14/997,006

(22) Filed: Jan. 15, 2016

Related U.S. Application Data
(63) Continuation of application No. 62/105,066, filed on Jan. 19, 2015.

(51) Int. Cl. A63B 69/00; A63B 69/20; F16M 13/02

(52) U.S. Cl. CPC A63B 69/004; F16M 13/02; A63B 69/201; A63B 69/205; F16M 2200/024

(57) ABSTRACT

A martial arts training system disclosed herein includes the mounting assembly, the heavy bag, and head bags. The mounting assembly comprises a support plate section, an angle adjustment joint, and an angle adjustment dog. The angle adjustment joint comprising a plurality of first openings is attached to the support plate section. The angle adjustment dog is attached to the angle adjustment joint, wherein the adjustment dog comprising a multiple second openings. A locking pin is inserted between the first openings and second openings to set an angle of inclination for the angle adjustment dog, wherein the head bag is positioned above the heavy bag at a desired angle of inclination of a user. The heavy bag is mounted from a track assembly via chain sections to receive low punches and kicks from the user, and the head bags are selectively attached above the heavy bag via to receive head punches from the user.

### CROSS REFERENCE TO RELATED APPLICATIONS

This application claims the benefit of provisional patent application No. 62/105,066 titled “MARTIAL ARTS TRAINING SYSTEM AND APPARATUS,” filed in the United States Patent and Trademark Office on Jan. 19, 2015. The specification of the above referenced patent application is incorporated herein by reference in its entirety.

### BACKGROUND

Development of the martial arts is an ancient and enduring human pursuit. Early art and literature, as well as archaeological findings depict fights and battles dating back over five thousand years. Wrestling exists in many forms spread across different cultures and practiced as a combat sport. Boxing has prehistoric origin as an Olympic sport in 688 BC. Modern boxing evolved from 16th and 18th century as prizefights, particularly in Great Britain. According to legend, the first documented “boxing match” took place in 1681 in Britain when the Duke of Albemarle organized a fight between his butler and his butcher. Boxing styles can often be broken down into three main styles of boxing: outside fighter, brawler, and inside fighter.

These styles refer to the most common techniques used by a boxer during a fight. Kickboxing is a related style of fighting that developed from karate, Muay Thai, Taekwondo, and Western Boxing. While the roots of kickboxing are ancient, the popularization of modern kickboxing occurred in the west during the 1960's and 1970's. Despite the long history of these fighting traditions, training technology still leaves much to be desired. There is a need to combine a traditional heavy bag with a head bag, and include systems to sense pressure of the punches and kicks, and so that these systems may be mounted on a track. Eighty percent of punches and kicks are thrown targeting the head, whereas conventional punching bags do not support users to train uppercut workout. There is a need for a device or a system, which allows fighters to train uppercuts, cross punches, kicks, clinch moves, and combination moves on a single apparatus. The device or system should also enable fighters to train with combinations of techniques and to gauge the effectiveness of their hits.

Hence, there is a long felt but unresolved need for a martial arts training system comprising a mounting assembly, which enables a user to mount one or more head bags to a heavy bag, whereby the user can practice more head punches on one or more head bags and combination kicks on the heavy bags simultaneously.

### SUMMARY OF THE INVENTION

The mounting assembly is configured to attach a head bag to a standard heavy bag used in martial arts training, and the mounting assembly comprises a support plate section, an angle adjustment joint, and an angle adjustment dog. The angle adjustment joint fixedly attached to the support plate section, wherein the angle adjustment joint comprises two semi-annular segments comprising multiple first openings. The angle adjustment dog is hingedly attached within a space defined between the semi-annular segments of the angle adjustment joint, wherein the angle adjustment dog comprises multiple second openings. A locking pin is axially inserted between the first openings of the angle adjustment joint and second openings of the angle adjustment dog to set an angle of inclination for the angle adjustment dog. The head bag is fastened to one of the second openings of the angle adjustment dog and the head bag can be positioned above the heavy bag at a desired angle of inclination by a user.

In an embodiment, four support plate sections are attached together in a generally rectangular manner, where the angle adjustment joint and the angle adjustment dog are positioned on the support plate sections in a generally radially outward orientation. In an embodiment, one head bag is attached to the mounting assembly and mounted on top portion of a heavy bag, and the whole assembly is configured to traverse along a track assembly. In an embodiment, four head bags are attached to the mounting assembly, and the mounting assemblies are further attached to the heavy bag, where the heavy bag along with head bag is configured to move horizontally along the track assembly. In an embodiment, the support plate section further comprises fastening holes configured to fasten the mounting assembly to chain sections hingedly attached to the track assembly.

A martial arts training system is also disclosed herein comprising the mounting assembly, the heavy bag, and one or more head bags. The heavy bag is mounted from a track assembly via one or more chain sections, where the heavy bag is configured to receive low punches and kicks from a user, and the head bags are selectively attached above the heavy bag via one or more mounting assemblies, where the head bags are configured to receive head punches from the user. In an embodiment, heavy bag further comprises a pressure sensor array, which is configured to monitor the pressure of the kicks and punches applied on the heavy bag by the user. In an embodiment, one or more filler materials are filled within the head bag. In an embodiment, the heavy bag is segmented into a plurality of compartments, and further the compartments are filled with one or more of the filler materials.

### BRIEF DESCRIPTION OF THE DRAWINGS

FIG. 1A is a perspective view of a mounting assembly configured to mount a head bag.

FIG. 1B is a perspective view of the angle adjustment joint of the mounting assembly.

FIG. 1C is a perspective view of the angle adjustment dog of the mounting assembly.

FIG. 2 is a top perspective view of an embodiment of an assembly of mounting assemblies, which demonstrate four mounting assemblies attached together.

FIG. 3 is a perspective view of the heavy bag and head bag on the track assembly, illustrates a martial arts training system and demonstrates the location of the pressure sensor array.

FIG. 4 is a plain front view of the heavy bag and four head bags on the track assembly.

### DETAILED DESCRIPTION OF THE INVENTION

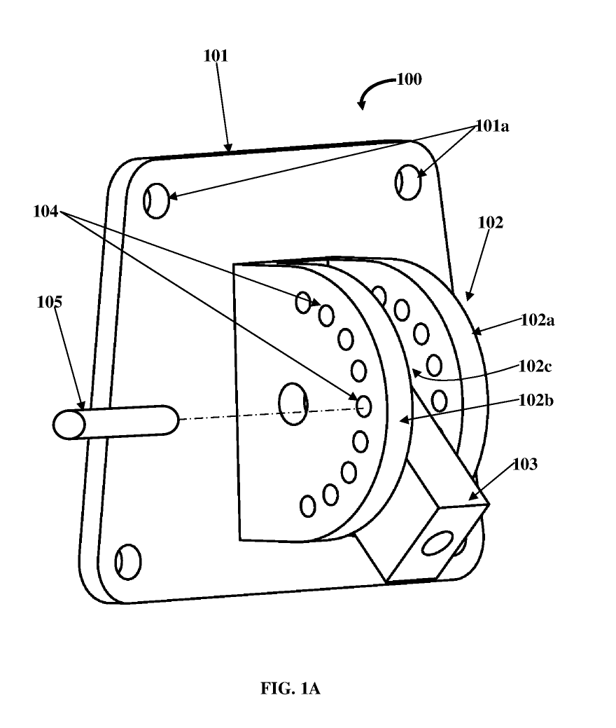

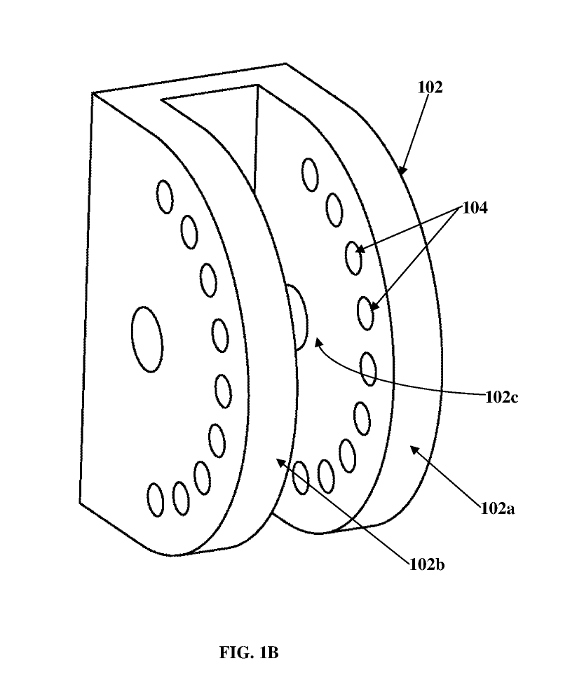

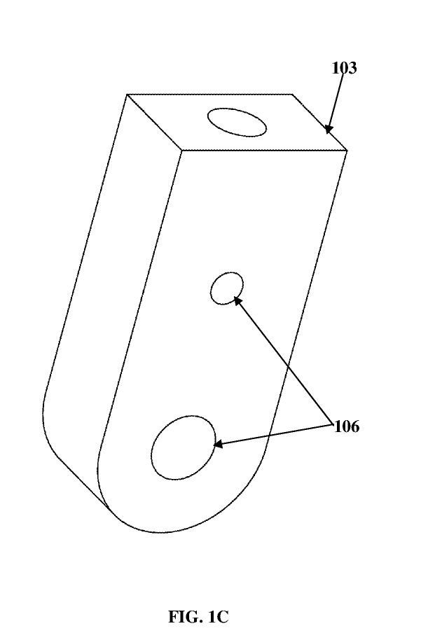

FIG. 1A is a perspective view of a mounting assembly 100 configured to attach a head bag 107, FIG. 1B is a perspective view of the angle adjustment joint 102 of the mounting assembly 100, and FIG. 1C is a perspective view of the angle adjustment dog 103 of the mounting assembly 100. In general, during martial arts training, over eighty percent of punches and kick are thrown to the head. Therefore, there is a need for a martial arts training system and apparatus where a head bag 107 should be attached to a heavy bag 108 or a punching bag. Therefore, a mounting assembly 100 is used to achieve this goal. The mounting assembly 100 is configured to attach a head bag 107 to a standard heavy bag 108 used in martial arts training, and the mounting assembly 100 comprises a support plate section 101, an angle adjustment joint 102, and an angle adjustment dog 103.

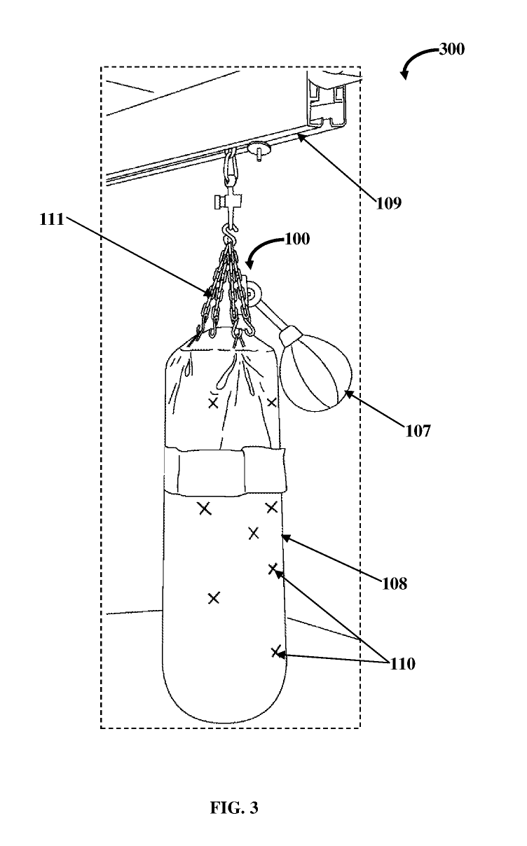

As shown in FIG. 1A and FIG. 1B, the angle adjustment joint 102 is attached perpendicular to the plane of the support plate section 101, wherein the angle adjustment joint 102 comprises two substantially semicircular segments or two semi-annular segments 102a and 102b defining a narrow space 102c there between to receive an angle adjustment dog 103. Each of the segments 102a, 102b comprises multiple first openings 104. The angle adjustment dog 103 comprises multiple second openings 106 as shown in FIG. 1C. The angle adjustment dog 103 is hingedly attached to the angle adjustment joint 102 by positioning within the narrow space 102c between the semi-annular segments 102a and 102b. A locking pin 105 is axially inserted through one of the first opening 104 present in the semi-annular segments 102a and 102b so that it connects with a second opening 106 of the angle adjustment dog 103 at a predefined angle, as shown in FIG. 1A. The angle adjustment dog 103 can be detachably interlocked with the angle adjustment joint 102 using the locking pin 105 at a desired angle of inclination. The head bag 107 is fastened to one of the second openings 106 of the angle adjustment dog 103 and configured to be positioned over the heavy bag 108 at a desired angle of inclination of the user. In an embodiment, the support plate section 101 further comprises fastening holes 101a as further explained in FIG. 3.

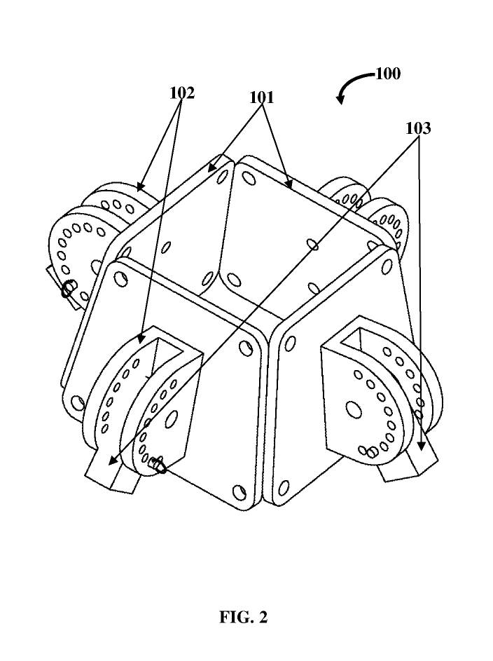

FIG. 2 is a top perspective view of an embodiment of an assembly of mounting assemblies 100, which demonstrate four mounting assemblies 100 attached together. Here, in an embodiment, the four support plate sections 101 facing four directions are welded together to form a generally rectangular structure as shown in FIG. 2, where the angle adjustment joint 102 and the angle adjustment dog 103 are positioned in a generally radially outward orientation extending from the support plate sections 101. The assembled formation as shown in this FIG. 2 is then positioned over the heavy bag 108 as shown in FIG. 3.

FIG. 3 is a perspective view of the heavy bag 108 and head bag 107 on a track assembly 109, the heavy bag demonstrating the location of the pressure sensor array 110. In an embodiment, the support plate section 101 further comprises fastening holes 101a as shown in FIG. 1A, configured to fasten the mounting assembly 100 to chain sections 111 hingedly attached to a track assembly 109 as shown in FIG. 3. In a first embodiment, one head bag 107 is attached to the mounting assembly 100, and then connected to the heavy bag 108, where the head bag 107 is configured to traverse along a track assembly 109. The mounting assembly 100 further comprises the track assembly 109 on which the head bag 107, heavy bag 108, and mounting assembly 100 are configured to slide laterally.

A martial arts training system 300, as shown in FIG. 3 comprises the mounting assembly 100, the head bag 107, and the heavy bag 108. The heavy bag 108 is mounted to hang from a track assembly 109 via one or more of the chain sections 111, wherein the heavy bag 108 is configured to receive low punches and kicks from a user. The head bags 107 are selectively attached above the heavy bag 108 via one or more mounting assemblies 100, wherein the head bags 107 are configured to receive head punches from the user. The heavy bag 108 further comprises a pressure sensor array 110, which is configured to monitor the pressure of the kicks and punches applied on the heavy bag 108 by the user. In an embodiment, one or more filler materials are filled within the head bag 107, instead of conventional air bladder bags that has the tendency to burst or can be popped. Whereas, the head bag 107 of the present invention is filled with filler materials comprising, for example, high-density foam.

Conventional heavy bags are generally filled with mulched blue jean material, which will settle over time at the bottom of the heavy bag, thereby making the bottom of the heavy bag as hard and the top of the heavy bag as soft. Therefore, in another embodiment, the heavy bag 108 of the present invention is segmented into multiple compartments, for example, 8-10 compartments which are filled with mulched rubber bands, which in turn will keep the heavy bag 108 filled evenly and also give a realistic movement advantage. The heavy bag 108 also enable fighters to train the nerve endings on their shins and forearms as it will be hard enough to train for at the same time not too soft in reaction to the punches thrown on the heavy bag 108. Further, the heavy bag 108 will function like a toy snake where the user can wave so that the heavy bag 108 will bend and move like the body would when kicked.

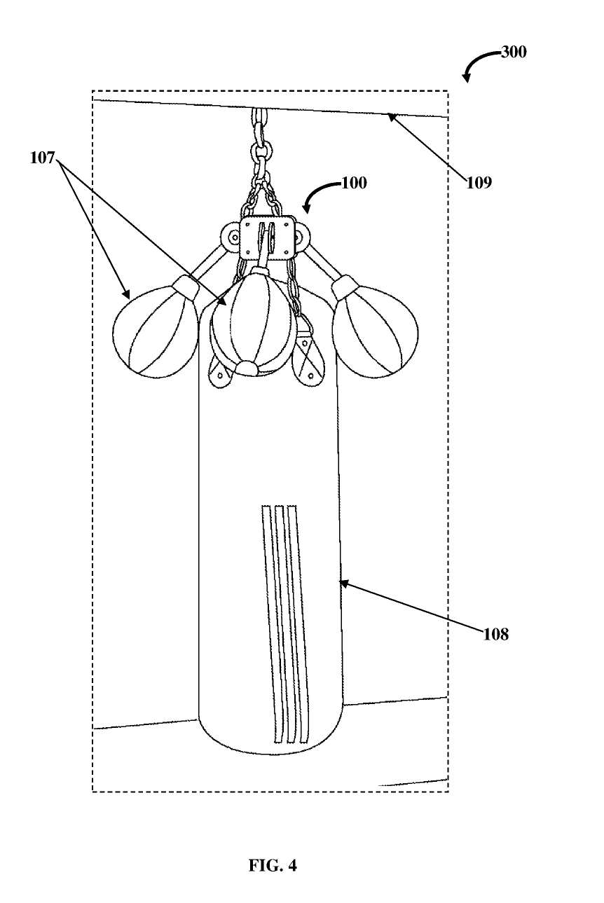

FIG. 4 is a plain front view of the heavy bag 108 and four head bags 107 on the track assembly 109. In a second embodiment, four head bags 107 are attached to the head bag mounting assembly 101. Conventional punching bags do not enable the user to perform an uppercut workout. The mounting assembly 100 enables a user to accomplish all of the punches and kicks in a combination approach. The mounting assembly 100 mimics the actual movements and addresses the technique and form needed to train more effectively. The martial arts training system 300 enables a user to train for a complete fight scenario. Although the martial arts training system 300 has been explained in relation to its preferred embodiment, it is to be understood that many other possible modifications and variations can be made without departing from the spirit and scope of the invention.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

I claim:

1. A mounting assembly for attaching one or more head bags to a heavy bag used in martial arts training, comprising:
at least one support plate section;
an angle adjustment joint fixedly attached perpendicularly to a plane of the support plate section, wherein the angle adjustment joint comprises two semi-annular segments comprising a plurality of first openings; and
an angle adjustment dog hingedly attached within a space defined between the semi-annular segments of the angle adjustment joint, wherein the angle adjustment dog comprises a plurality of second openings, wherein a locking pin is axially inserted between the first openings of the angle adjustment joint and second openings of the angle adjustment dog to set an angle of inclination for the angle adjustment dog, wherein the head bag is fastened to one of the second openings of the angle adjustment dog and configured to be positioned above the heavy bag at a desired angle of inclination of the user.

2. The mounting assembly of claim 1, wherein four support plate sections are welded together in a generally rectangular manner, wherein the angle adjustment joint and the angle adjustment dog are positioned in a generally radially outward orientation.

3. The mounting assembly of claim 1, wherein one head bag is attached to the mounting assembly, and the mounting assembly is further attached to the heavy bag, and wherein the head bag is configured to traverse along a track assembly.

4. The mounting assembly of claim 3, wherein four head bags are attached to the mounting assembly, and the mounting assemblies are further attached to the heavy bag, and wherein the head bag is configured to traverse along the track assembly.

5. The mounting assembly of claim 1, wherein the support plate section further comprises fastening holes configured to fasten the mounting assembly to chain sections hingedly attached to the track assembly.

6. A martial arts training system, comprising:
a mounting assembly configured to mount one or more head bags to a heavy bag used in martial arts training, comprising:
at least one support plate section;
an angle adjustment joint fixedly attached perpendicularly to a plane of the support plate section, wherein the angle adjustment joint comprises two semi-annular segments comprising a plurality of first openings; and
an angle adjustment dog hingedly within a space defined between the semi-annular segments of the angle adjustment joint, wherein the angle adjustment dog comprises a plurality of second openings, wherein a locking pin is axially inserted between the first openings of the angle adjustment joint and second openings of the angle adjustment dog to set an angle of inclination for the angle adjustment dog, wherein the head bag is fastened to one of the second openings of the angle adjustment dog and configured to be positioned above the heavy bag at a desired angle of inclination of the user;
the heavy bag mounted from a track assembly via one or more chain sections, wherein the heavy bag is configured to receive low punches and kicks from the user; and
one or more of the head bags selectively attached above the heavy bag via one or more mounting assemblies which are fastened to the chain sections, wherein the head bags are configured to receive head punches from the user.

7. The martial arts training system of claim 6, wherein the heavy bag further comprises a pressure sensor array, wherein the pressure sensor array is configured to monitor the pressure of the kicks and punches applied on the heavy bag by the user.

8. The martial arts training system of claim 6, wherein one or more filler materials are filled within the head bag.

9. The martial arts training system of claim 6, wherein the heavy bag is segmented into a plurality of compartments, and further the compartments are filled with one or more of the filler materials.
